(19) United States
(12) Patent Application Publication
(10) Pub. No.: US 2016/0353340 A1
(43) Pub. Date: Dec. 1, 2016

(54) INTER-RAT (RADIO ACCESS TECHNOLOGY) AND INTRA-RAT MEASUREMENT REPORTING

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/802,897

(22) Filed: Jul. 17, 2015

Related U.S. Application Data
(60) Provisional application No. 62/168,650, filed on May 29, 2015.

(51) Int. Cl. H04W 36/00; H04W 36/30

(52) U.S. Cl. CPC H04W 36/0066; H04W 36/0083; H04W 36/30; H04W 88/06

(57) ABSTRACT

A measurement report may trigger a handover based on relative signal strengths of a serving cell and an intra/inter-RAT (radio access technology) neighbor cell. This may result in a UE being handed over to a weak cell and cause a voice call to drop. A method of wireless communication includes determining whether to delay sending an inter-RAT or an intra-RAT measurement report based in part on a current status of a call setup and whether the UE and a network support an inter-RAT handover while in the current status of the call setup. The measurement report is delayed for a predetermined time period based in part on the determination. The method also includes sending the measurement report when the predetermined time period expire and/or the current status of the call setup changes to a new status when both the UE and the network support the inter-RAT handover.

### CROSS-REFERENCE TO RELATED APPLICATION

This application claims the benefit under 35 U.S.C. §119(e) to U.S. Provisional Patent Application No. 62/168,650, entitled “INTER-RAT (RADIO ACCESS TECHNOLOGY) AND INTRA-RAT MEASUREMENT REPORTING,” filed on May 29, 2015, the disclosure of which is expressly incorporated by reference herein in its entirety.

### BACKGROUND

Field

Aspects of the present disclosure relate generally to wireless communication systems, and more particularly, to inter-radio access technology (IRAT) and intra-RAT measurement reporting.

Background

Wireless communication systems are widely deployed to provide various telecommunication services, such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is long term evolution (LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the present disclosure, a method of wireless communication at a user equipment (UE) is presented. The method includes determining whether to delay sending an inter-RAT (inter-radio access technology) measurement report or an intra-RAT measurement report based at least in part on a current status of the call setup and whether both the UE and a network support an inter-RAT handover while in the current status of the call setup. The network may be a serving network or a target network. The method further includes delaying sending the intra-RAT measurement report for an intra-RAT measurement report holding time period and/or the inter-RAT measurement report for an inter-RAT measurement report holding time period based at least in part on the determination. The method also includes sending the intra-RAT measurement report and/or the inter-RAT measurement report when the intra-RAT measurement report holding time period and/or the inter-RAT measurement report holding time period expire and/or the current status of the call setup changes to a new status in which both the UE and the network support the inter-RAT handover.

In another aspect of the present disclosure, an apparatus for wireless communication is presented. The apparatus includes means for determining whether to delay sending an inter-RAT (inter-radio access technology) measurement report or an intra-RAT measurement report based at least in part on a current status of the call setup and whether both the UE and a network support an inter-RAT handover while in the current status of the call setup. The network may be a serving network or a target network. The apparatus further includes means for delaying sending the intra-RAT measurement report for an intra-RAT measurement report holding time period and/or the inter-RAT measurement report for an inter-RAT measurement report holding time period based at least in part on the determination. The method also includes means for sending the intra-RAT measurement report and/or the inter-RAT measurement report when the intra-RAT measurement report holding time period and/or the inter-RAT measurement report holding time period expire and/or the current status of the call setup changes to a new current status of the call setup in which in which both the UE and the network support the inter-RAT handover.

In yet another aspect of the present disclosure, an apparatus for wireless communication is presented. The apparatus includes a memory, at least one processor coupled to the memory and a transceiver configured to communicated with a network. The processor(s) is configured to determine whether to delay sending an inter-RAT (inter-radio access technology) measurement report or an intra-RAT measurement report based at least in part on a current status of the call setup and whether both the UE and a network support an inter-RAT handover while in the current status of the call setup. The network may be a serving network or a target network. The processor(s) is further configured to delay sending the intra-RAT measurement report for an intra-RAT measurement report holding time period and/or the inter-RAT measurement report for an inter-RAT measurement report holding time period based at least in part on the determination. The processor(s) is also configured to send the intra-RAT measurement report and/or the inter-RAT measurement report when the intra-RAT measurement report holding time period and/or the inter-RAT measurement report holding time period expire and/or the current status of the call setup changes to a new current status of the call setup in which both the UE and the network support the inter-RAT handover.

In still another aspect of the present disclosure, a computer program product for wireless communication is presented. The computer program product includes a non-transitory computer-readable medium having encoded thereon program code. The program code includes program code to determine whether to delay sending an inter-RAT (inter-radio access technology) measurement report or an intra-RAT measurement report based at least in part on a current status of the call setup and whether both the UE and a network support an inter-RAT handover while in the current status of the call setup, the network being a serving network or a target network. The program code further includes program code to delay sending the intra-RAT measurement report for an intra-RAT measurement report holding time period and/or the inter-RAT measurement report for an inter-RAT measurement report holding time period based at least in part on the determination. The program code also includes program code to send the intra-RAT measurement report and/or the inter-RAT measurement report when the intra-RAT measurement report holding time period and/or the inter-RAT measurement report holding time period expire and/or the current status of the call setup changes to a new current status of the call setup in which both the UE and the network support the inter-RAT handover.

In an aspect of the present disclosure, a method of wireless communication at a network is presented. The method includes determining whether to delay sending to a user equipment (UE) an inter-radio access technology (RAT) handover command or an intra-RAT handover command based at least in part on a current status of a call setup and whether the UE and the network support an inter-RAT handover while in the current status of the call setup, the network being a serving network or a target network. The method further includes delaying sending the intra-RAT handover command for an intra-RAT handover holding time period and/or the inter-RAT handover command for an inter-RAT handover holding time period based at least in part on the determination. The method also includes sending the intra-RAT handover command and/or the inter-RAT handover command when the intra-RAT handover holding time period and/or the inter-RAT handover holding time period expire, and/or the call setup changes to a new current status in which both the UE and the network support the inter-RAT handover.

In another aspect of the present disclosure, an apparatus for wireless communication is presented. The apparatus includes means for determining whether to delay sending to a user equipment (UE) an inter-radio access technology (RAT) handover command or an intra-RAT handover command based at least in part on a current status of a call setup and whether the UE and the network support an inter-RAT handover while in the current status of the call setup, the network being a serving network or a target network. The apparatus further includes means for delaying sending the intra-RAT handover command for an intra-RAT handover holding time period and/or the inter-RAT handover command for an inter-RAT handover holding time period based at least in part on the determination. The apparatus also includes means for sending the intra-RAT handover command and/or the inter-RAT handover command when the intra-RAT handover holding time period and/or the inter-RAT handover holding time period expire, and/or the call setup changes to a new current status in which both the UE and the network support the inter-RAT handover.

In yet another aspect of the present disclosure, an apparatus for wireless communication at a network is presented. The apparatus includes a memory and at least one processor coupled to the memory. The processor(s) is configured to determine whether to delay sending to a user equipment (UE) an inter-radio access technology (RAT) handover command or an intra-RAT handover command based at least in part on a current status of a call setup and whether the UE and the network support an inter-RAT handover while in the current status of the call setup, the network being a serving network or a target network. The processor(s) is further configured to delay sending the intra-RAT handover command for an intra-RAT handover holding time period and/or the inter-RAT handover command for an inter-RAT handover holding time period based at least in part on the determination. The processor(s) is also configured to send the intra-RAT handover command and/or the inter-RAT handover command when the intra-RAT handover holding time period and/or the inter-RAT handover holding time period expire, and/or the call setup changes to a new current status in which both the UE and the network support the inter-RAT handover.

In still another aspect of the present disclosure, a computer program product for wireless communication at a network is presented. The computer program product includes a non-transitory computer-readable medium having encoded thereon program code. The program code includes program code to determine whether to delay sending to a user equipment (UE) an inter-radio access technology (RAT) handover command or an intra-RAT handover command based at least in part on a current status of a call setup and whether the UE and the network support an inter-RAT handover while in the current status of the call setup, the network being a serving network or a target network. The program code further includes program code to delay sending the intra-RAT handover command for an intra-RAT handover holding time period and/or the inter-RAT handover command for an inter-RAT handover holding time period based at least in part on the determination. The program code also includes program code to send the intra-RAT handover command and/or the inter-RAT handover command when the intra-RAT handover holding time period and/or the inter-RAT handover holding time period expire, and/or the call setup changes to a new current status in which both the UE and the network support the inter-RAT handover.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a diagram illustrating an example of a downlink frame structure in LTE.

FIG. 3 is a diagram illustrating an example of an uplink frame structure in LTE.

FIG. 4 is a block diagram conceptually illustrating an example of a base station in communication with a UE in a telecommunications system.

FIG. 5 illustrates exemplary network coverage areas including a first RAT network and a second RAT wireless network according to aspects of the present disclosure.

FIG. 6 is a block diagram illustrating a wireless communication network in accordance with aspects of the present disclosure.

FIG. 7 is an exemplary call flow diagram illustrating a signaling procedure in accordance with aspects of the present disclosure.

FIG. 8 is a flow diagram illustrating an example decision process for intra-RAT and inter-RAT measurement reporting according to aspects of the present disclosure.

FIG. 9 is a flow diagram illustrating a method for intra-RAT and inter-RAT measurement reporting according to aspects of the present disclosure.

FIG. 10 is a flow diagram illustrating a method for intra-RAT and inter-RAT handover according to aspects of the present disclosure.

FIG. 11 is a block diagram illustrating different modules/means/components for inter-RAT and/or intra-RAT measurement reporting in an example apparatus according to one aspect of the present disclosure.

FIG. 12 is a block diagram illustrating different modules/means/components for inter-RAT and/or intra-RAT handover in an example apparatus according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

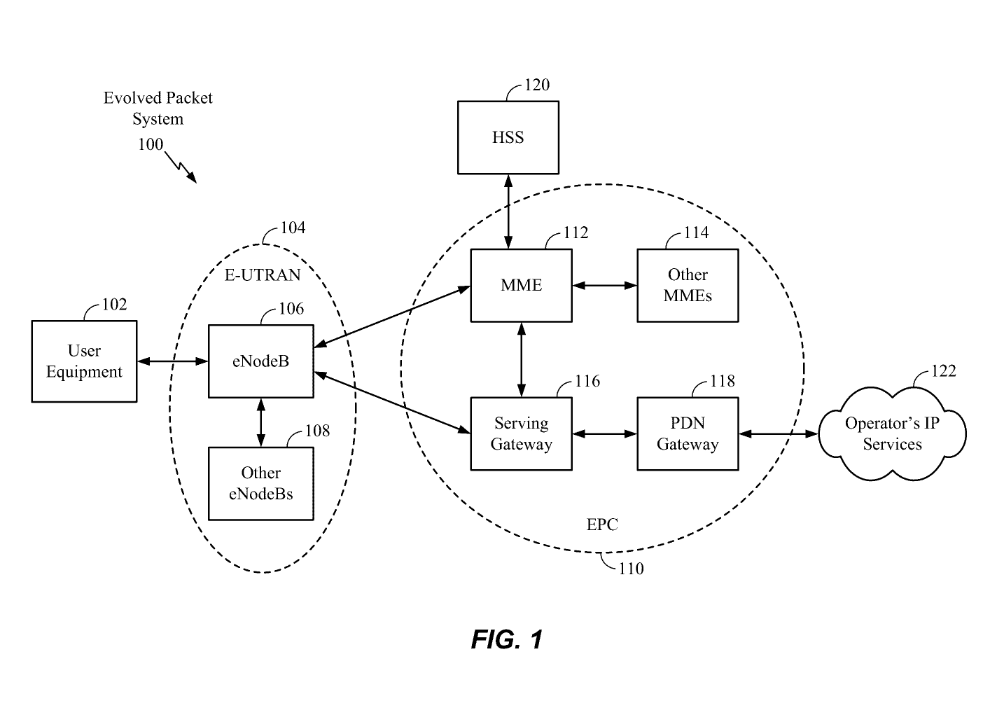

FIG. 1 is a diagram illustrating an LTE network architecture 100. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a packet switched (PS) streaming service (PSS).

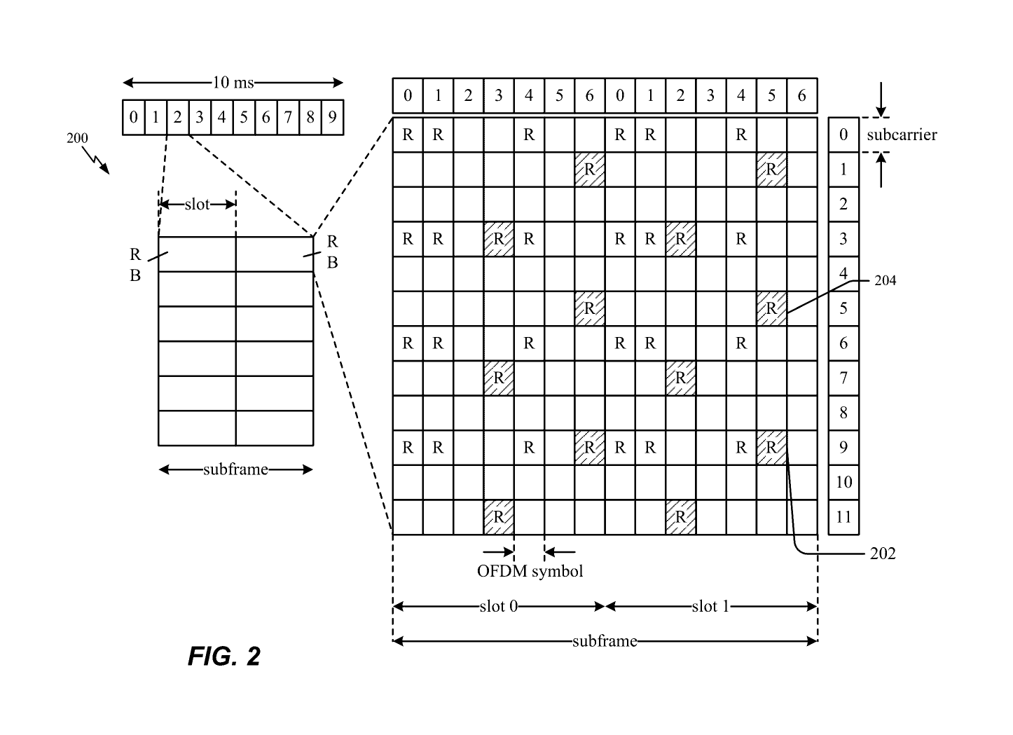

FIG. 2 is a diagram 200 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, for a total of 84 resource elements. For an extended cyclic prefix, a resource block contains 6 consecutive OFDM symbols in the time domain, resulting in 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

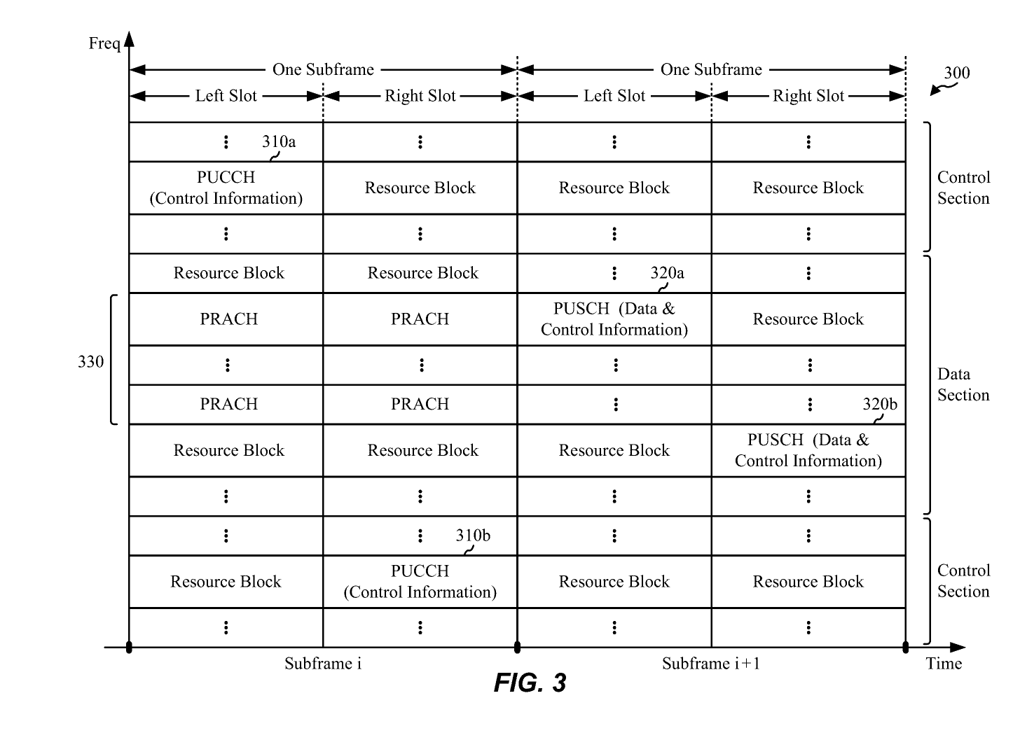

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

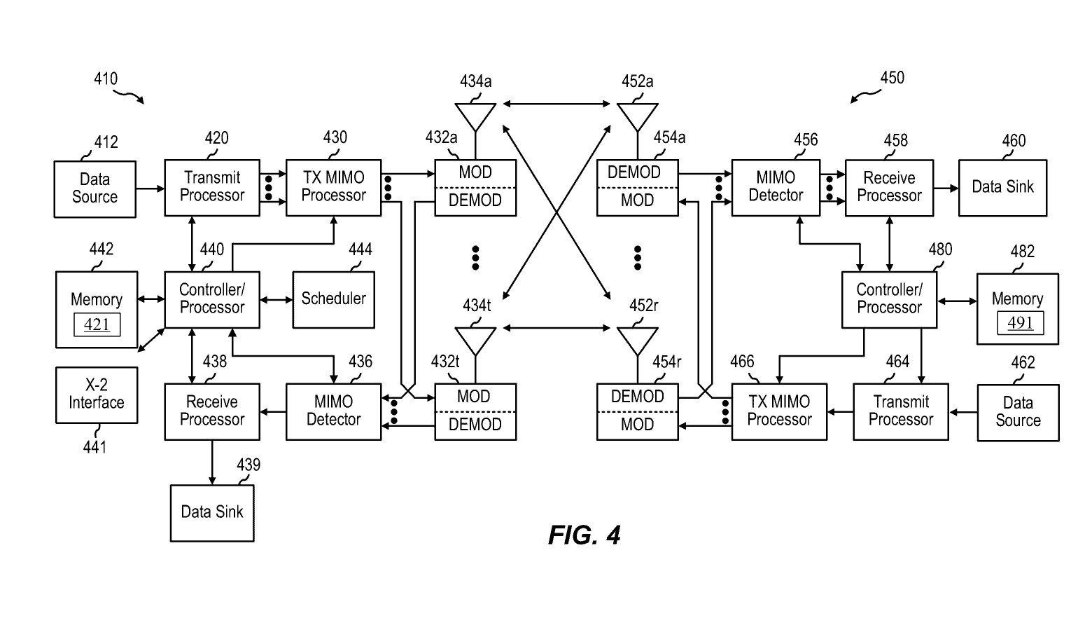

FIG. 4 shows a block diagram of a design of a base station 410 and a UE 450, which may be one of the base stations/eNodeBs and the UE in FIG. 1. For example, the base station 410 may be the macro eNodeB 106 in FIG. 1, and the UE 450 may be the UE 102 of FIG. 1. The base station 410 may also be a base station of some other type. The base station 410 may be equipped with antennas 434a through 434t, and the UE 450 may be equipped with antennas 452a through 452r.

At the base station 410, a transmit processor 420 may receive data from a data source 412 and control information from a controller/processor 440. The control information may be for the physical broadcast channel (PBCH), physical control format indicator channel (PCFICH), physical hybrid-ARQ indicator channel (PHICH), physical downlink control channel (PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 450, the antennas 452a through 452r may receive the downlink signals from the base station 410 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 450 to a data sink 460, and provide decoded control information to a controller/processor 480.

On the uplink, at the UE 450, a transmit processor 464 may receive and process data (e.g., for the physical uplink shared channel (PUSCH)) from a data source 462 and control information (e.g., for the physical uplink control channel (PUCCH)) from the controller/processor 480. The processor 464 may also generate reference symbols for a reference signal. The symbols from the transmit processor 464 may be precoded by a TX MIMO processor 466 if applicable, further processed by the modulators 454a through 454r (e.g., for SC-FDM, etc.), and transmitted to the base station 410. At the base station 410, the uplink signals from the UE 450 may be received by the antennas 434, processed by the demodulators 432, detected by a MIMO detector 436 if applicable, and further processed by a receive processor 438 to obtain decoded data and control information sent by the UE 450. The processor 438 may provide the decoded data to a data sink 439 and the decoded control information to the controller/processor 440. The base station 410 can send messages to other base stations, for example, over an X2 interface 441.

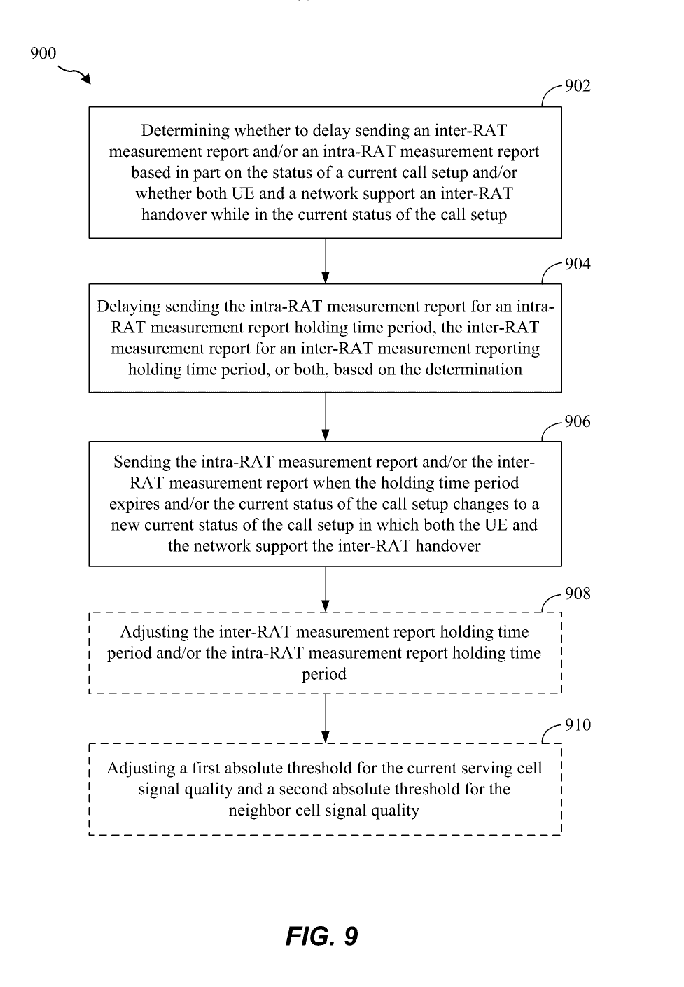

The controllers/processors 440 and 480 may direct the operation at the base station 410 and the UE 450, respectively. The processor 440/380 and/or other processors and modules at the base station 410/UE 450 may perform or direct the execution of the functional blocks illustrated in method flow chart FIG. 9 and/or other processes for the techniques described herein. A scheduler 444 may schedule UEs for data transmission on the downlink and/or uplink. The memories 442 and 482 may store data and program codes for the base station 410 and the UE 450, respectively. For example, the memory 482 of the UE 450 may store a measurement reporting module 491, which, when executed by the controller/processor 480, configures the UE 450 to report inter-RAT and/or intra-RAT measurements. For another example, the memory 442 of the base station 410 may store a handover management module 421, which, when executed by the controller/processor 440, configures the base station 410 to send or delay sending handover commands

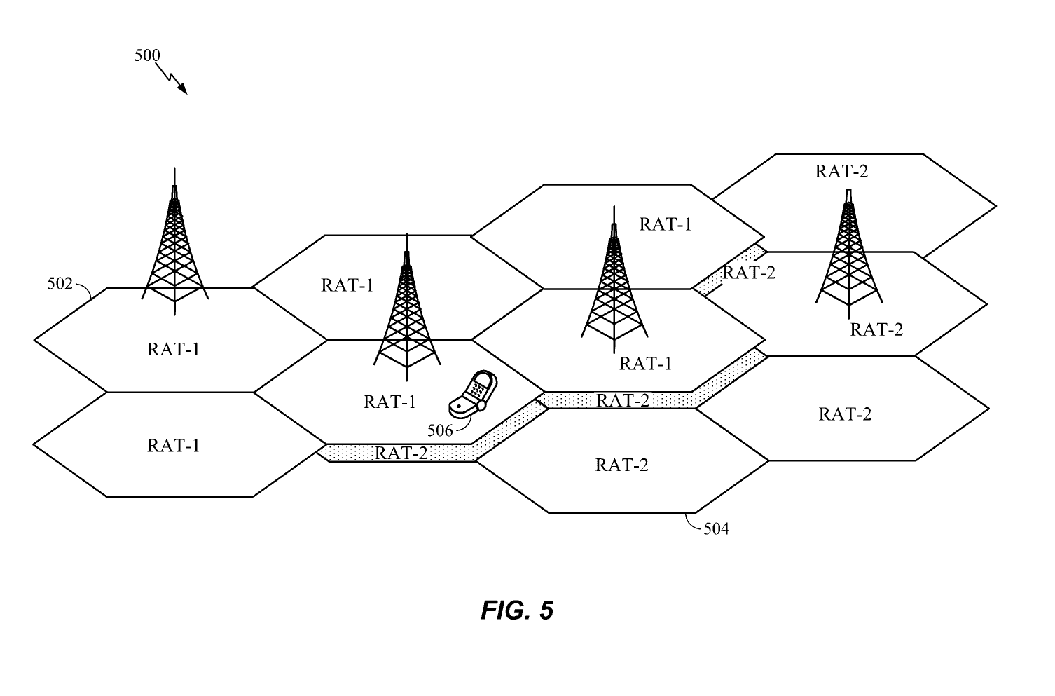

FIG. 5 illustrates exemplary network coverage areas. In particular, the geographical area 500 includes RAT-1 cells 502 and RAT-2 cells 504. In one example, the RAT-1 cells are LTE cells and the RAT-2 cells are 2G or 3G cells. However, those skilled in the art will appreciate that other types of radio access technologies may be utilized within the cells. A user equipment (UE) 506 may move from one cell, such as a RAT-1 cell 502, to another cell, such as a RAT-2 cell 504 The movement of the UE 506 may trigger a handover or a cell reselection. Movement between different types of RATs is denoted by the term inter-RAT. Movement within a same RAT is denoted as intra-RAT.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter-radio access technology (IRAT) measurement.

The UE may send a serving cell a measurement report indicating results of the inter-RAT (IRAT) measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Ongoing communication on the UE may be handed over from the first RAT to a second RAT based on measurements performed on the second RAT. For example, the UE may tune away to the second RAT to perform the measurements. Examples of ongoing communications on the UE include communications according to a single radio voice call continuity (SRVCC) procedure. SRVCC is a solution aimed at providing continuous voice services on packet-switched networks (e.g., LTE networks). In the early phases of LTE deployment, when UEs running voice services move out of an LTE network, the voice services can continue in the legacy circuit-switched (CS) domain using SRVCC, ensuring voice service continuity. SRVCC is a method of inter-radio access technology (IRAT) handover. SRVCC enables smooth session transfers from voice over internet protocol (VoIP) over the IP multimedia subsystem (IMS) on the LTE network to circuit-switched services in the universal terrestrial radio access network (UTRAN) or GSM enhanced date rates for GSM Evolution (EDGE) radio access network (GERAN).

LTE coverage is limited in availability. When a UE conducting a packet-switched voice call (e.g., voice over LTE (VoLTE) call) leaves LTE coverage or when the LTE network is highly loaded, SRVCC may be used to maintain voice call continuity from a packet-switched (PS) call to a circuit-switched call during IRAT handover scenarios. SRVCC may also be used, for example, when a UE has a circuit-switched voice preference (e.g., circuit-switched fallback (CSFB)) and packet-switched voice preference is secondary if combined attach fails. The evolved packet core (EPC) may send an accept message for packet-switched attach in which case a VoIP/IMS capable UE initiates a packet-switched voice call.

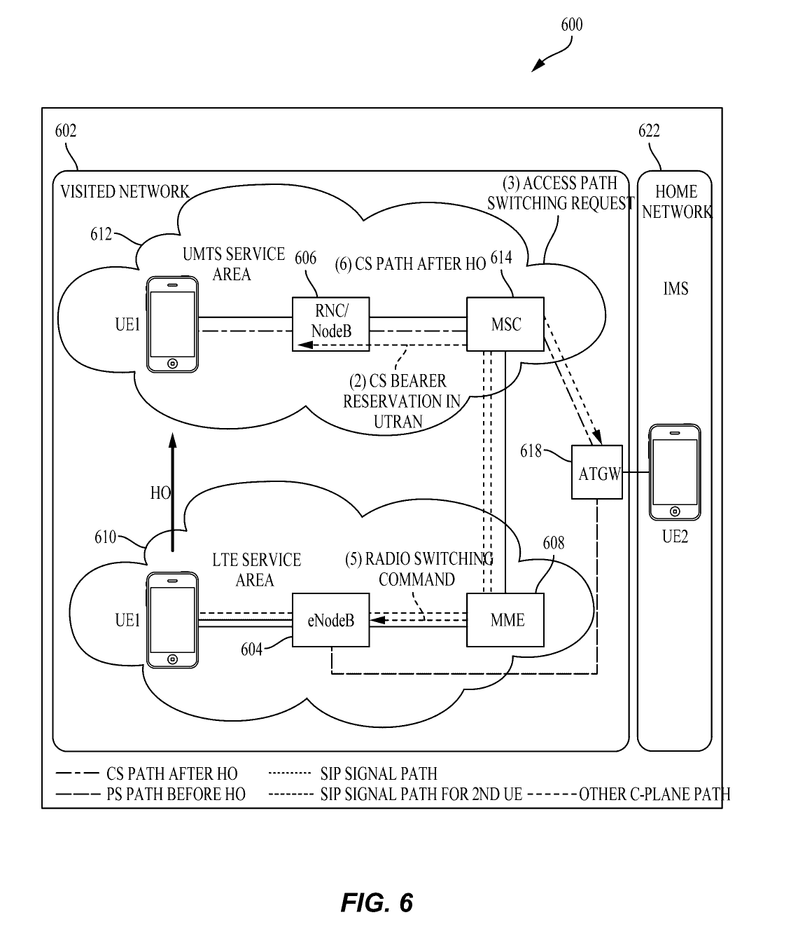

A UE may perform an LTE serving cell measurement. When the LTE serving cell signal strength or quality is below a threshold (meaning the LTE signal may not be sufficient for an ongoing call), the UE may report an event 2A (change of the best frequency). In response to the measurement report, the LTE network may send radio resource control (RRC) reconfiguration messages indicating 2G/3G neighbor frequencies. The RRC reconfiguration message also indicates event B1 (neighbor cell becomes better than an absolute threshold) and/or B2 (a serving RAT becomes worse than a threshold and the inter-RAT neighbor become better than another threshold). The LTE network may also allocate LTE measurement gaps. For example, the measurement gap for LTE is a 6 ms gap that occurs every 40 or 80 ms. The UE uses the measurement gap to perform 2G/3G measurements and LTE inter-frequency measurements. When the LTE eNode B receives the event B1 report from the UE, the LTE eNode B may initiate the SRVCC procedure. The SRVCC procedure may be implemented in a wireless network, such as the wireless network of FIG. 6.

FIG. 6 is a block diagram illustrating a wireless communication network 600 in accordance with aspects of the present disclosure. Referring to FIG. 6, the wireless communication network may include a visited network 602 and a home network 622. The visited network 602 may include multiple service areas. For example, as shown in FIG. 6, without limitation, the visited network 602 may include an LTE service area 610 and a UMTS service area 612. A first UE (UE1) located in the LTE service area 610 may conduct a voice call with a second UE (UE2), which is located in the home network 622. In one aspect, UE1 may conduct a voice call (e.g., a PS call or VoLTE) with UE2 via the access transfer gateway (ATGW) 618.

When UE1 leaves the LTE service area 610, the LTE serving cell (eNodeB 604) signal strength or signal quality may fall below a threshold. As such, UE1 may report an event 2A. In turn, the eNode B 604 may provide an RRC connection reconfiguration message to UE1. The RRC connection reconfiguration message may include measurement configuration information such as the LTE measurement gap allocation. For example, the LTE gap allocation may be such that a 6 ms measurement gap occurs every 40 ms.

Accordingly, UE1 may conduct the IRAT and inter-frequency measurements and provide a corresponding measurement report to the eNode B 604, which may initiate the handover of coverage to the Node B 606 of the UMTS service area 612. The mobility management entity (MME) 608 may initiate an SRVCC procedure for the handover. A switch procedure may be initiated to transfer the voice call to a circuit-switched network. An access path switching request is sent via the mobile switching center (MSC) 614, which routes the voice call to UE2 via the access transfer gateway (ATGW) 618. Thereafter, the call between UE1 and UE2 may be transferred to a circuit-switched call. The various communication links or paths are represented by solid and different dashed lines. The communication paths include circuit-switched (CS) path after handover (HO), packet-switched path before handover, session initiation protocol (SIP) signal path, session initiation protocol signal path for a second UE (UE2) and a communication plane (C-plane) path.

An undesirable event may occur when the LTE serving or a different intra or inter-frequency neighbor cells are weak but relatively better than the signal quality of the current serving cell and the UE still performs the handover to the target cell. When the UE performs handover to the target cell after receiving a handover command, in these cases, a call failure may occur.

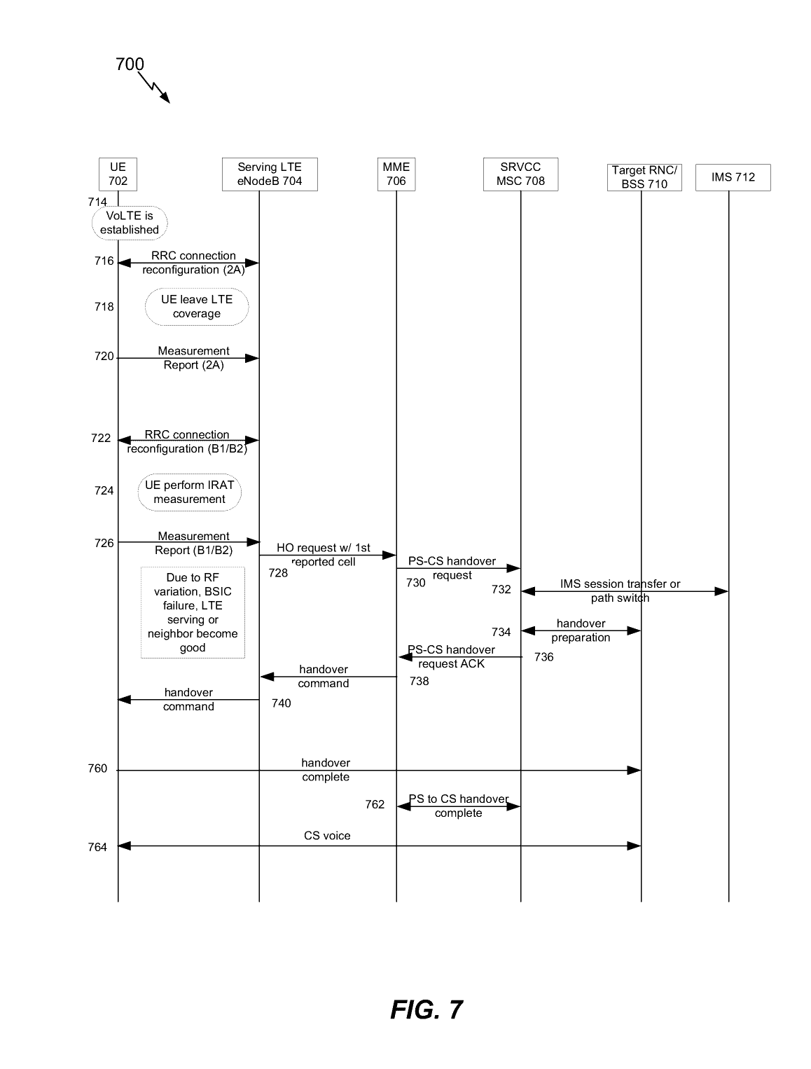

FIG. 7 is an exemplary call flow diagram 700 illustrating a signaling procedure in accordance with aspects of the present disclosure. At time 714, a user equipment (UE) 702 is in an original operation mode, such as a connected mode or a dedicated channel (DCH) mode with a packet-switched (PS) RAT (e.g., LTE). For example, in one aspect, the UE may conduct a voice call (e.g., a PS call or VoLTE) via the serving LTE eNodeB 704.

At time 716, the serving LTE eNodeB 704 sends a first radio resource control (RRC) connection reconfiguration message to a UE 702. The first RRC connection configuration message may include the measurement configuration with information about the measurement gap resources. For example, the first RRC connection configuration message may be directed to inter-frequency handover measurements and events, such as event 2A. The event 2A based RRC connection configuration message may result from the UE leaving a coverage area of the serving LTE eNodeB 704, at time 718. At time 720, the UE 702 sends an event 2A measurement report to the serving LTE eNodeB 704.

In some aspects, the serving LTE eNodeB 704 sends a second RRC connection reconfiguration message to the UE 702. The second RRC connection configuration message may also include the measurement configuration with information about the measurement gap resources. For example, the second RRC connection configuration message may be directed to event B1 when an inter-RAT neighbor becomes better than a threshold. The second RRC connection configuration message may also be directed to event B2 when a serving RAT becomes worse than a threshold and the inter-RAT neighbor become better than another threshold. At time 724, the UE 702 performs the inter-RAT measurement. At time 726, the UE 702 sends an event B1/B2 measurement report to the serving LTE eNodeB 704.

The serving LTE eNodeB 704 provides an indication of whether handover is desirable (e.g., with a first reported cell) to a mobility management entity (MME) 706, at time 728. In turn, at time 730, the mobility management entity 706 initiates SRVCC for circuit-switched (CS) and packet-switched (PS) handovers. For example, the mobility management entity 706 transmits a packet-switched to circuit-switched handover request to an SRVCC mobile switching center (MSC) server 708. In turn, at time 732, the SRVCC mobile switching center server 708 begins an internet protocol multimedia subsystem (IMS) service continuity procedure with an internet protocol multimedia subsystem 712. The procedure may include an internet protocol multimedia subsystem session transfer procedure or a path switch procedure. For example, the path switch procedure includes switching a voice communication path from LTE to 2G or 3G.

At time 734, the SRVCC mobile switching center server 708 begins circuit-switched/packet-switched handover preparation with a target radio network controller (RNC)/base station subsystem (BSS) 710. At time 736, the SRVCC mobile switching center server 708 sends a handover response message to the mobility management entity 706. The handover response message may include a packet-switched to circuit-switched handover request acknowledgment (ACK). At time 738, the mobility management entity 706 sends a message to the eNode B 704 including a handover command. At time 740, the eNode B 704 provides a handover command to the UE 702 instructing the UE to handover communications from the eNode B 704 to the target radio network controller (RNC)/base station subsystem (BSS) 710.

In the handover procedure, the target cell is available and the UE 702 is not prematurely handed over to the target cell. Accordingly, after receiving the handover command at time 760, a handover complete message is sent to the target radio network controller (RNC)/base station subsystem (BSS) 710. At time 762, the SRVCC mobile switching center server 708 completes circuit-switched/packet-switched handover with the mobility management entity 706. At time 764, the circuit-switched voice call is established with the target radio network controller (RNC)/base station subsystem (BSS) 710.

### Inter-RAT and Intra-RAT Measurement Reporting and Handover

During a VoLTE (voice over LTE) call, a UE may continuously perform LTE serving cell measurements. As discussed above, when the signal quality of the LTE serving cell falls below a predetermined threshold, the UE may report an event A2. In response to the report, the LTE serving cell sends radio resource control (RRC) reconfiguration messages indicating 2G/3G neighbor frequencies, and an event B1 threshold. The LTE serving cell may also allocate LTE measurement gaps. The UE uses the measurement gaps to perform the 2G/3G measurements and LTE inter-frequency measurements. When an LTE nodeB receives a B1 event report from the UE and when the signal quality of the target 2G/3G cell is below the threshold indicated in the B1 event, the LTE nodeB may initiate an SRVCC inter-RAT handover procedure, as indicated at time 728 of FIG. 7.

The LTE network may also configure intra- and inter-frequency measurements and reports, based on the event A3. The event A3 occurs when the neighbor cell signal quality is above the serving cell signal quality by an offset indicated by a network, and lasts for a time to trigger duration. The UE sends a measurement report for an A3 event, which triggers handover. That is, the UE may perform an LTE intra and/or inter-frequency neighbor cell measurement. In previous approaches, when the neighbor cell signal quality is above the LTE serving cell, the UE sends a measurement report which in turn triggers an intra-LTE handover.

The intra-RAT and -inter-RAT measurement reports are configured to run in parallel independently, each with a time to trigger (TTT) timer. When a TTT timer expires, the UE sends the measurement report corresponding to the expired timer. In some scenarios, the UE may handover to a weak LTE neighbor cell and miss the chance to handover to a good 2G/3G cell in the SRVCC procedure. This may result in a VoLTE call being dropped.

Aspects of the present disclosure are directed to reducing call drops in LTE before an SRVCC procedure. In particular, the UE may delay sending intra- or inter-RAT measurement reports based on a combination of factors, such as the LTE serving cell signal quality, the neighbor cell signal quality and/or the current status of a call setup. Those skilled in the art will appreciate the term “signal quality” is non-limiting. Signal quality is intended to cover any type of signal metric, such as, but not limited to signal strength, signal power, signal quality, etc.

In one example, when the quality of the LTE serving cell signal is below an absolute threshold (e.g., a first UE-defined threshold) and the quality of the neighbor cell signal is below another absolute threshold (e.g., a second UE-defined threshold), the UE may delay sending an intra-RAT (e.g., intra-LTE) measurement report for a predefined period (e.g., measurement report holding time period). Further, the UE may delay sending the intra-RAT measurement report even when the corresponding TTT timer has expired. In one aspect, the UE sends the intra-RAT measurement report when the signal qualities of the LTE serving cell and the neighbor cell are both above the predefined absolute thresholds (e.g., the first UE-defined threshold, the second UE-defined threshold).

Additionally, the UE may delay sending the inter-RAT measurement report for another predefined period of time (e.g., the measurement report holding time period) even after the corresponding TTT timer has expired. The UE may send an inter-RAT measurement report if the LTE call setup is completed. The predefined absolute thresholds and the predefined measurement report holding time periods may be adjusted based on factors such as, but not limited to: a UE speed, a UE receiver performance, a serving cell radio frequency (RF) variation trend, and application quality of service (QoS) specifications, among others.

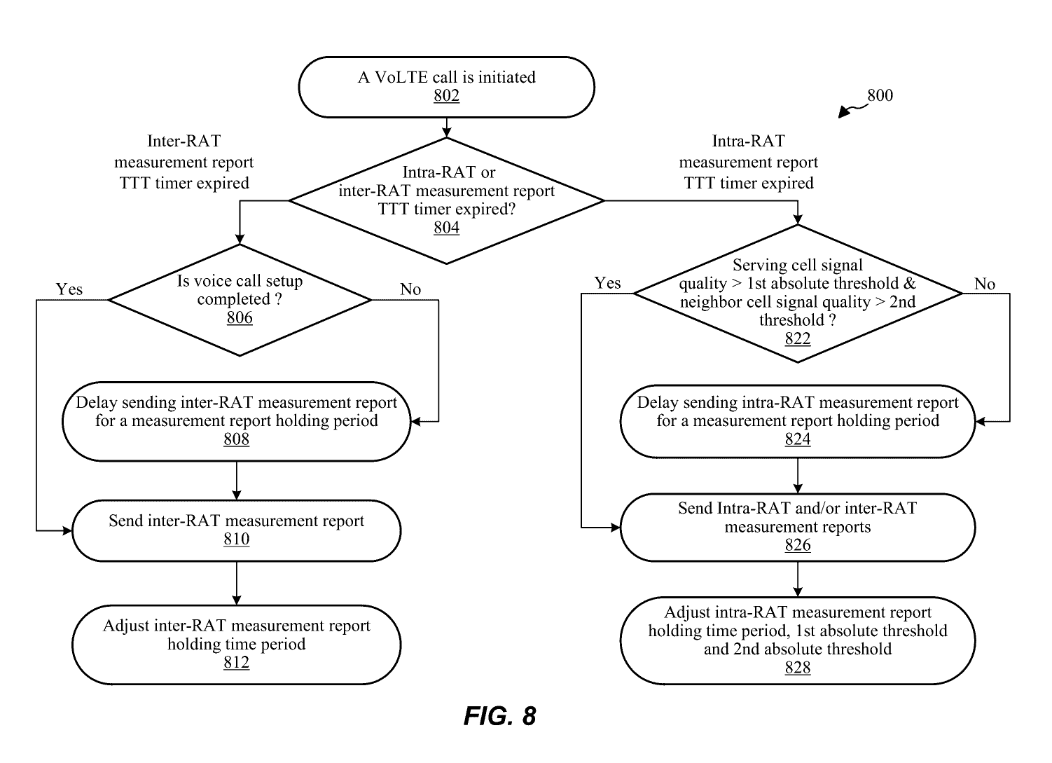

FIG. 8 is a flow diagram illustrating an example flow diagram 800 for inter-RAT and intra-RAT measurement reporting according to aspects of the present disclosure. The flow diagram 800 is for illustration purposes only and other alternative aspects of the decision process for measurement reports are certainly possible.

At block 802, a call is initiated by the UE. In the following example, an LTE voice call is discussed, however, the present disclosure is not so limited. For example, voice over WLAN (wireless local area network), video over LTE, video over WLAN, etc. is also contemplated. At block 804, the UE determines whether TTT timers have expired. In particular, the UE monitors a time to trigger (TTT) timer for an inter-RAT measurement and a TTT timer for the intra-RAT measurement report. In one example aspect, the two timers may run independently. One of the timers may expire before the other, or at the same time.

According to one aspect of the present disclosure, when the inter-RAT measurement report TTT timer expires, the UE checks the voice call setup status, at block 806 and determines whether the setup is complete. If the UE determines the call setup is not complete, the UE may delay sending the inter-RAT measurement report for a predetermined holding time period, as shown in block 808. When the predetermined holding time period expires, the UE may send the inter-RAT measurement report, at block 810, to the serving base station.

If the UE determines, at block 806, the voice call setup is complete, the UE may send the inter-RAT measurement report without any delay, to trigger an inter-RAT handover to a 2G/3G network. At block 812, the UE may adjust the inter-RAT measurement report holding time period based on factors such as a UE speed, a current serving cell radio frequency (RF) variation trend, a number of inter-RAT neighbor cells, the application QoS specifications and a percentage of call setup completion. In the above example, the LTE call setup status is a factor for determining whether to delay sending an inter-RAT measurement report.

Referring back to block 804, when the intra-RAT measurement report TTT timer expires, the UE may evaluate cell signal qualities. In particular, at block 822, the UE determines whether the current LTE serving cell signal quality is above a first UE-defined threshold and whether a neighbor cell signal quality is above a second UE-defined threshold. If the UE determines either or both of the signal qualities are below the absolute threshold(s), the UE proceeds to block 824 and delays sending the intra-RAT measurement report for a predefined intra-RAT measurement report holding time period. When the intra-RAT measurement report holding time period expires, the UE sends the intra-RAT measurement report to the serving base station without further delay. Optionally, the UE may delay sending the intra-RAT measurement report when the difference in signal quality between the serving cell and the neighbor cell is below a relative threshold.

If the UE determines at block 822 that both the signal qualities are above the absolute thresholds, the UE proceeds to block 826, and sends the intra-RAT measurement report without delay. Optionally, the UE may send the intra-RAT measurement report, without delay, when the relative difference in signal quality between the serving cell and the neighbor cell is above a relative threshold.

At block 828, the UE adjusts the first and the second absolute signal quality thresholds. The adjustment may be based on a UE speed, a UE receiver performance and a serving cell radio frequency (RF) variation trend, and/or application quality of service (QoS) specifications. The UE may also adjust the intra-RAT measurement report holding time period based on UE speed, the current serving cell RF variation trend, a number of intra-frequency neighbors, and/or the application QoS specifications.

FIG. 9 is a flow diagram illustrating a method 900 for intra-RAT and inter-RAT measurement reporting during a call setup, according to aspects of the present disclosure. At block 902, the UE in an LTE voice call setup may determine whether to delay sending an inter-RAT measurement report and/or an intra-RAT measurement report, after the corresponding TTT timer has expired. The determination may be based at least in part on a status of a call setup. Optionally, the determination may also consider the signal quality of a current serving cell and/or the signal quality of a neighbor cell. The determination may also be based on whether the current serving cell of a first RAT or a neighbor cell of a second RAT provides a better QoS to an active service or application running at the UE.

In one example aspect, determining whether to delay sending an inter-RAT measurement report and/or intra-RAT measurement report may be based on a status of the LTE voice call setup. For example, the voice call setup may be in a pre-alerting stage, alerting stage, before default bearer establishment for signaling stage, after default bearer establishment for signaling stage, before dedicated bearer establishment for traffic stage or after dedicated bearer establishment for traffic stage. If the voice call setup is in a stage other than the after dedicated bearer establishment stage, the UE may determine to delay send the inter-RAT measurement report. The inter-RAT measurement report may trigger an inter-RAT handover from the current LTE network to a 2G/3G network. The voice call may be dropped at the 2G/3G network if the LTE call setup is not completed when the handover takes place. The current status of the call setup may include alerting, pre-alerting, before default bearer establishment for signaling (e.g. voice over LTE IMS signaling), after default bearer establishment for signaling, before dedicated bearer establishment for traffic and after dedicated bearer establishment for traffic.

In another example aspect, determining whether to delay sending the intra-LTE measurement report may be based on a first UE-defined absolute threshold for the neighbor cell signal quality and a second UE-defined absolute threshold for the current serving cell signal quality. In one example where both the serving LTE cell signal quality and LTE neighbor cell signal quality are weak, but the neighbor LTE cell signal quality is relatively better than the current serving cell signal quality, an intra-RAT (e.g., intra-LTE) measurement report may trigger a handover to the weak neighbor cell. The call may be dropped because of the weak signal quality of the neighbor cell.

In another example, when determining whether to delay sending a measurement report, the UE considers whether the serving LTE cell signal quality is above the first UE-defined absolute threshold and the neighbor LTE cell is above a second UE-defined absolute threshold. When the signal quality of each is above the associated threshold, the UE may determine not to delay sending the intra-RAT measurement report without any delay.

At block 904, the UE delays sending the inter-RAT measurement report and/or the intra-RAT measurement report based on the determination. Further, the UE delays sending the measurement report for a particular amount of time (e.g., inter-RAT measurement report holding time period, intra-RAT measurement report holding time period).

In another example, the UE delays sending an intra-RAT measurement report for the intra-RAT measurement report holding time period. During the intra-RAT measurement report holding time period, the conditions that cause the UE to delay sending the intra-RAT measurement report may have changed. For example, the LTE neighbor cell signal quality and the current serving cell signal quality may both become higher than the corresponding UE-defined absolute thresholds. In yet another example, the UE delays sending the intra-RAT measurement report when a signal quality difference between the current serving cell and an intra-RAT neighbor cell is below a UE-defined relative threshold.

At block 904, delaying sending the inter-RAT measurement report by the UE may include reducing a frequency of inter-RAT measurements when at least one of the UE, the serving network and the target network does not support the inter-RAT handover while in the current status of the call setup.

At block 906, the UE sends the intra-RAT measurement report, once the intra-RAT measurement report holding time period expires. The UE may send the inter-RAT measurement report when the inter-RAT measurement report holding time period expires. In another example aspect, the UE may also send the intra-RAT measurement report or inter-RAT measurement report before the corresponding measurement report holding time periods expire, when the conditions that cause the UE to delay sending the measurement report have changed before the measurement report holding time periods expire. For example, if the neighbor cell signal quality and the current serving cell signal quality become above the respective UE-defined absolute thresholds, the UE may send the measurement report without waiting for the measurement report holding time period expires. For another example, the UE sends the intra-RAT measurement report when a signal quality difference between the current serving cell and intra-RAT neighbor cell is above a relative threshold.

At block 906, the UE may optionally send the inter-RAT measurement report when a current call is in the call setup or when at least one of the UE, a serving network or a target network supports an inter-RAT handover during the call setup, and a signal quality of each of the serving cell and an intra-RAT neighbor cell become lower than the first UE-defined absolute threshold.

In one example, the UE may optionally adjust the intra-RAT measurement report holding time period, as shown in block 908. The adjustment may be based on a UE speed, a UE receiver performance and a serving cell radio frequency (RF) variation trend, and/or application quality of service (QoS) specifications. For example, if the UE speed is high, the intra-RAT measurement report holding time period may be set relatively short because the UE may move out of the serving cell within a relatively short period of time. In another example, if the UE receive performance is poor, the intra-RAT measurement report holding time period may be set relatively long because it may take longer for the UE to receive correct transmissions. In yet another example, if the serving cell radio frequency (RF) variation trend indicates that serving cell signal quality is becoming worse and the neighbor cell radio frequency (RF) variation trend indicates the neighbor cell signal quality is becoming better, the intra-RAT measurement report holding time period may be set shorter, so the UE may be handed over to the neighbor cell faster.

At block 908, the UE may also optionally adjust the inter-RAT measurement report holding time period based on a UE speed, a UE receiver performance, a percentage of call setup completion and/or application quality of service (QoS) specifications. For example, if the UE speed is high, the inter-RAT measurement report holding time period may be set relatively short because the UE may move out of this serving RAT within a relatively short period of time. In another example, if the UE receiver performance is poor, the inter-RAT measurement report holding time period may be set relatively long because it may take longer for the UE to receive correct transmissions. In yet another example, if the percentage of the call setup completion is high, the inter-RAT measurement report holding time period may be set relatively short because the call setup is expected to be completed soon.

Additionally, in another optional example, the UE may optionally adjust a first UE-defined threshold for the current serving cell signal quality and a second UE-defined threshold for the neighbor cell signal quality, as shown in optional block 910. The optional adjustment may be based on a UE speed, a UE receiver performance and/or a serving cell radio frequency (RF) variation trend, and application quality of service (QoS) specifications, among others. For example, if the UE speed is high, the first UE-defined threshold may be set relatively low so it may be easier to cause the intra-RAT measurement report to be sent, because the UE may move out of this serving cell within a relatively short period of time.

In another example, if the UE receive performance is poor, the first UE-defined threshold may be set relatively low so that it would not take too longer for the intra-RAT measurement report to be triggered. In yet another example, if the serving cell radio frequency (RF) variation trend indicates that serving cell signal quality is becoming worse and the neighbor cell radio frequency (RF) variation trend indicates the neighbor cell signal quality is becoming better, the first UE-defined threshold and the second UE-defined threshold may be set relatively low, so the UE may be handed over to the neighbor cell faster.

In practice, one or more steps shown in illustrative method 900 may be combined with other steps, performed in any suitable order, performed in parallel (e.g., simultaneously or substantially simultaneously), or removed.

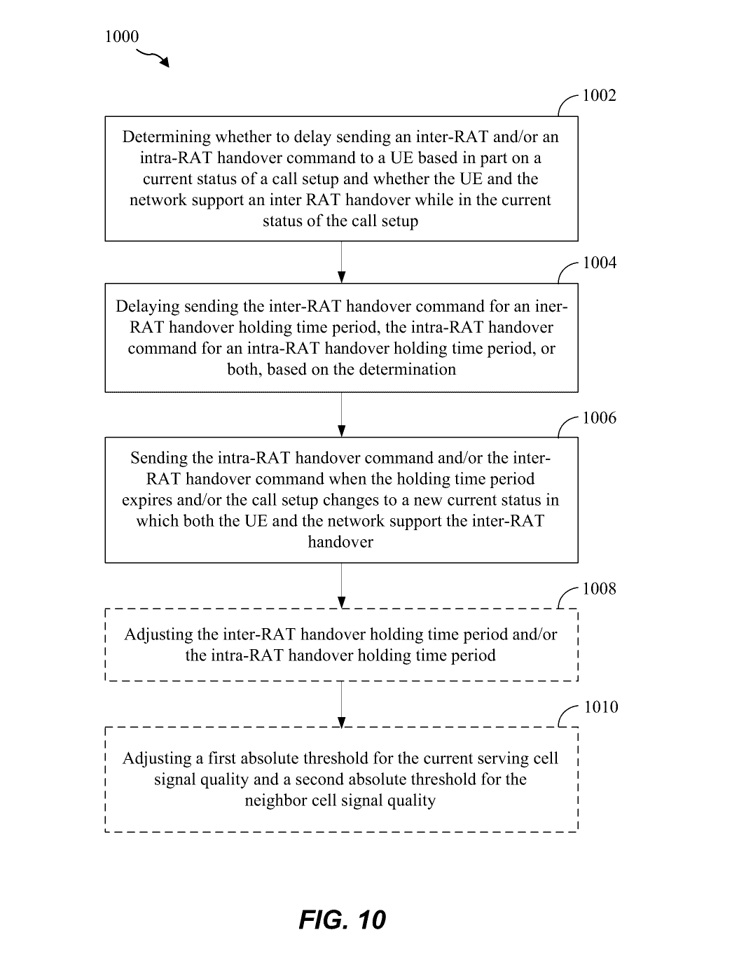

FIG. 10 is a flow diagram illustrating a method 1000 for intra-RAT and inter-RAT handover at a network during a call setup, according to aspects of the present disclosure. At block 1002, the network in an LTE voice call setup may determine whether to delay sending an inter-RAT handover command and/or an intra-RAT handover command to a UE. The determination may be based at least in part on a current status of the call setup. Optionally, the determination may also consider the signal quality of a current serving cell and/or the signal quality of a neighbor cell reported from the UE. The network may be a serving network or a target network for handover.

In one example aspect, determining whether to delay sending an inter-RAT handover command and/or intra-RAT handover command may be based on a current status of the LTE voice call setup. For example, the voice call setup may be in a call setup status such as a pre-alerting, alerting, before default bearer establishment for signaling, after default bearer establishment for signaling, before dedicated bearer establishment for traffic or after dedicated bearer establishment for traffic. If the voice call setup is in a stage other than the after dedicated bearer establishment for traffic, the network may determine to delay send the inter-RAT handover command. The voice call may be dropped at the 2G/3G network if the LTE call setup is not completed when the inter-RAT handover takes place.

In another example aspect, determining whether to delay sending the intra-LTE handover command may be based on a first network-defined absolute threshold for the neighbor cell signal quality and a second network-defined absolute threshold for the current serving cell signal quality. In one example where the serving LTE cell signal quality and LTE neighbor cell signal quality, as reported from the UE, are both weak, but the neighbor LTE cell signal quality is relatively better than the current serving cell signal quality, the network may send an intra-RAT (e.g., intra-LTE) handover to the weak neighbor cell. The call may be dropped because of the weak signal quality of the neighbor cell.

In another example, when determining whether to delay sending the handover command to the UE, the network considers whether the serving LTE cell signal quality, as reported from the UE, is above the first network-defined absolute threshold and the neighbor LTE cell signal quality is above a second network-defined absolute threshold. When the signal quality of each is above the associated threshold, the network may determine not to delay sending the intra-RAT handover command.

At block 1004, the network delays sending the inter-RAT handover command and/or the intra-RAT handover command based on the above determination. Further, the network delays sending the handover command for a particular amount of time (e.g., inter-RAT handover holding time period, intra-RAT handover holding time period).

In another example, the network delays sending an intra-RAT handover command for the intra-RAT handover holding time period. During the intra-RAT handover holding time period, the conditions that cause the network to delay sending the intra-RAT handover command may have changed. For example, the LTE neighbor cell signal quality and the current serving cell signal quality, as reported from the UE, may both become higher than the corresponding network-defined absolute thresholds. In yet another example, the network delays sending the intra-RAT handover command when a signal quality difference between the current serving cell and an intra-RAT neighbor cell is below a network-defined relative threshold (e.g., a first network-defined relative threshold).

At block 1006, the network sends the intra-RAT handover command, once the intra-RAT handover holding time period expires. The network may send the inter-RAT handover command when the inter-RAT handover holding time period expires. In another example aspect, the network may also send the intra-RAT handover command or inter-RAT handover command before the corresponding handover holding time periods expire, when the conditions that caused the network to delay sending the handover commands have changed before the handover holding time periods expire. For example, if the neighbor cell signal quality and the current serving cell signal quality, as reported from the UE, become above the respective network-defined absolute thresholds, the network may send the handover command without waiting for the handover holding time period expires. For another example, the network sends the intra-RAT handover command when a signal quality difference between the current serving cell and intra-RAT neighbor cell, as reported from the UE, is above a relative threshold (e.g., a second network-defined relative threshold).

At block 1006, the network may optionally send the inter-RAT handover command when the call setup changes to a new current status in which both the UE and the network support the inter-RAT handover and/or a signal quality of each of the serving cell and an intra-RAT neighbor cell become lower than the first network-defined absolute threshold.

In one example, the network may optionally adjust the intra-RAT handover holding time period, as shown in block 1008. The adjustment may be based on a UE speed as measured at the network, a current serving cell radio frequency variation trend, and/or application quality of service (QoS) specifications. For example, if the UE speed is high, the intra-RAT handover holding time period may be set relatively short because the UE may move out of the serving cell within a relatively short period of time. In another example, if the serving cell radio frequency (RF) variation trend, as reported from the UE, indicates that serving cell signal quality is becoming worse and the neighbor cell radio frequency variation trend indicates the neighbor cell signal quality is becoming better, the intra-RAT handover holding time period may be set shorter, so the network may have the UE handed over to the neighbor cell faster.

At block 1008, the network may also optionally adjust the inter-RAT handover holding time period based on a UE speed, a percentage of call setup completion and/or application quality of service (QoS) specifications. For example, if the UE speed is high, the inter-RAT measurement report holding time period may be set relatively short because the UE may move out of this serving RAT within a relatively short period of time. The UE speed may be measured by the network, based on uplink signals from the UE, the signals such as uplink sounding reference signals, uplink pilot channels, and demodulation reference signals. In yet another example, if the percentage of the call setup completion is high, the inter-RAT handover holding time period may be set relatively short because the call setup is expected to be completed soon.

Additionally, in another optional example, at block 1010, the network may adjust a first network-defined absolute threshold for the current serving cell signal quality and a second network-defined threshold for the neighbor cell signal quality, as shown in optional block 1010. The optional adjustment may be based on a UE speed, and/or a serving cell radio frequency (RF) variation trend, and application quality of service (QoS) specifications, among others. For example, if the UE speed is high, the first network-defined threshold may be set relatively low so it may be easier to trigger the handover command to be sent, because the UE may move out of this serving cell within a relatively short period of time.

In yet another example, if the serving cell radio frequency (RF) variation trend, as reported from the UE, indicates that serving cell signal quality is becoming worse and the neighbor cell radio frequency (RF) variation trend indicates the neighbor cell signal quality is becoming better, the first network-defined absolute threshold and the second network-defined absolute threshold may be set relatively low, so the handover command may be sent to cause the UE be handed over to the neighbor cell faster.

In practice, one or more steps shown in illustrative method 1000 may be combined with other steps, performed in any suitable order, performed in parallel (e.g., simultaneously or substantially simultaneously), or removed.

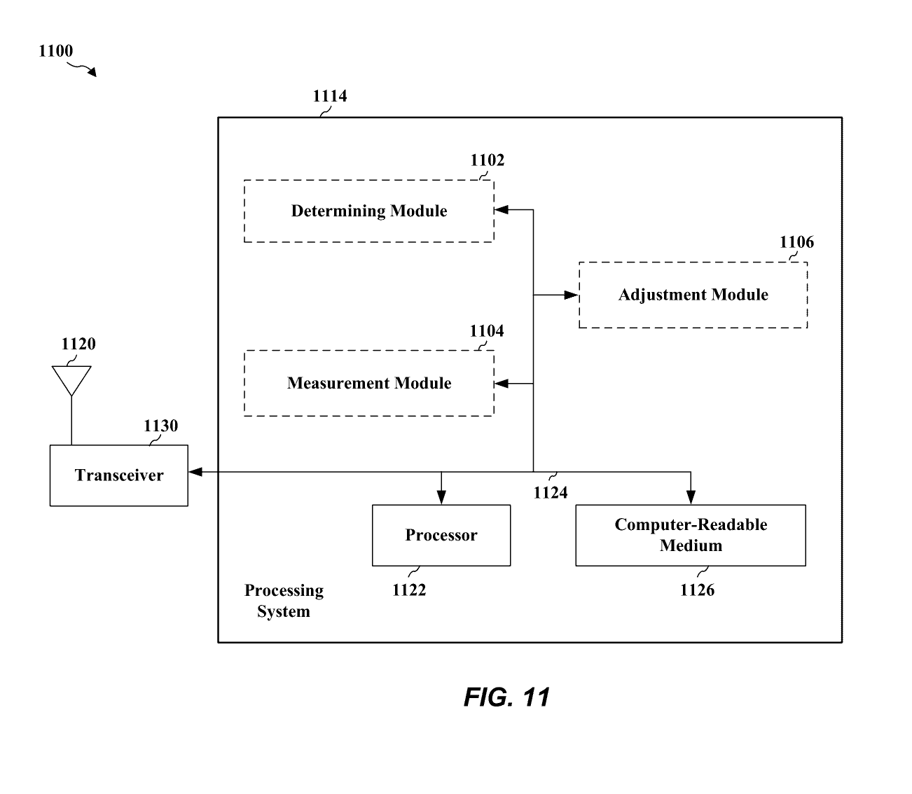

FIG. 11 is a block diagram illustrating an example of a hardware implementation for an apparatus 1100 employing a processing system 1114 with different modules/means/components for fast return failure handling in a high speed scenario in an example apparatus according to one aspect of the present disclosure. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1122 the modules 1102, 1104, 1106 and the non-transitory computer-readable medium 1126. The bus 1124 may also link various other circuits, such as timing sources, peripherals, voltage regulators, and power management circuits, which are well known in the art, and therefore, will not be described any further.

The apparatus includes a processing system 1114 coupled to a transceiver 1130. The transceiver 1130 is coupled to one or more antennas 1120. The transceiver 1130 enables communicating with various other apparatus over a transmission medium. The processing system 1114 includes a processor 1122 coupled to a non-transitory computer-readable medium 1126. The processor 1122 is responsible for general processing, including the execution of software stored on the computer-readable medium 1126. The software, when executed by the processor 1122, causes the processing system 1114 to perform the various functions described for any particular apparatus. The computer-readable medium 1126 may also be used for storing data that is manipulated by the processor 1122 when executing software.

The processing system 1114 includes a determining module 1102 for determining whether to delay sending an inter-RAT and/or intra-RAT measurement report. The processing system 1114 also includes a measurement module 1104 for sending and delaying sending of measurement reports. The processing system 1114 may also include an adjustment module 1106 for adjusting a measurement report holding time period and an absolute signal quality threshold. The modules 1102, 1104 and 1106 may be software modules running in the processor 1122, resident/stored in the computer-readable medium 1126, one or more hardware modules coupled to the processor 1122, or some combination thereof The processing system 1114 may be a component of the UE 450 of FIG. 4 and may include the memory 482, and/or the controller/processor 480.

In one configuration, an apparatus, such as a UE 450, is configured for wireless communication including means for determining whether to delay sending an inter-RAT or intra-RAT measurement report. In one aspect, the determining means may be the antennas 452, the receive processor 458, the controller/processor 480, the memory 482, the measurement reporting module 491, the determining module 1102, and/or the processing system 1114 configured to perform the functions recited by the determining means. In one configuration, the means and functions correspond to the aforementioned structures. In another aspect, the aforementioned means may be a module or any apparatus configured to perform the functions recited by the determining means.

The UE 450 is also configured to include means for delaying sending the measurement report. In one aspect, the delaying means may include the antennas 452, the transmit processor 464, the controller/processor 480, the memory 482, the measurement reporting module 491, the measurement module 1104, and/or the processing system 1114 configured to perform the functions recited by the delaying means. In one configuration, the means and functions correspond to the aforementioned structures. In another aspect, the aforementioned means may be a module or any apparatus configured to perform the functions recited by the delaying means.

The UE 450 is also configured to include means for sending the measurement report. In one aspect, the sending means may include the antennas 452, the transmit processor 464, the controller/processor 480, the memory 482, the measurement reporting module 491, the measurement module 1104, and/or the processing system 1114 configured to perform the functions recited by the delaying means. In one configuration, the means and functions correspond to the aforementioned structures. In another aspect, the aforementioned means may be a module or any apparatus configured to perform the functions recited by the sending means.

The UE 450 is also configured to include means for adjusting a measurement report holding time period and an absolute signal quality threshold. In one aspect, the adjusting means may include the antennas 452, the receive processor 458, the transmit processor 464, the controller/processor 480, the memory 482, the measurement reporting module 491, the measurement module 1104, the adjustment module 1106 and/or the processing system 1114 configured to perform the functions recited by the switching means. In one configuration, the means and functions correspond to the aforementioned structures. In another aspect, the aforementioned means may be a module or any apparatus configured to perform the functions recited by the adjusting means.

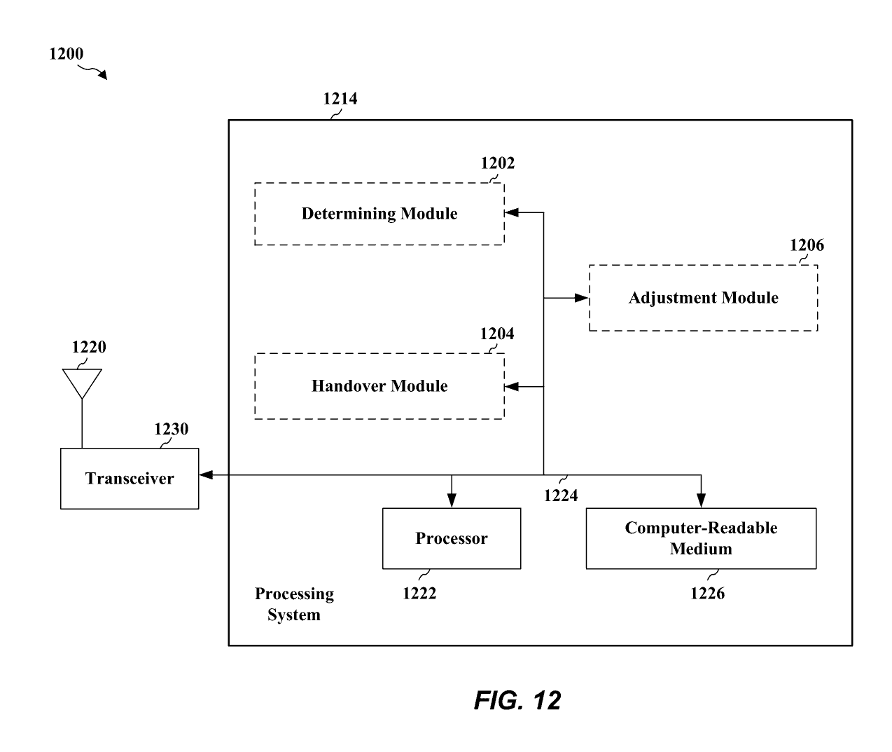

FIG. 12 is a block diagram illustrating an example of a hardware implementation for an apparatus 1200 employing a processing system 1214 with different modules/means/components for fast return failure handling in a high speed scenario in an example apparatus according to one aspect of the present disclosure. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1222, the modules 1202, 1204, 1206 and the non-transitory computer-readable medium 1226. The bus 1224 may also link various other circuits, such as timing sources, peripherals, voltage regulators, and power management circuits, which are well known in the art, and therefore, will not be described any further.

The apparatus includes a processing system 1214 coupled to a transceiver 1230. The transceiver 1230 is coupled to one or more antennas 1220. The transceiver 1230 enables communicating with various other apparatus over a transmission medium. The processing system 1214 includes a processor 1222 coupled to a non-transitory computer-readable medium 1226. The processor 1222 is responsible for general processing, including the execution of software stored on the computer-readable medium 1226. The software, when executed by the processor 1222, causes the processing system 1214 to perform the various functions described for any particular apparatus. The computer-readable medium 1226 may also be used for storing data that is manipulated by the processor 1222 when executing software.

The processing system 1214 includes a determining module 1202 for determining whether to delay sending an inter-RAT and/or intra-RAT handover command. The processing system 1214 also includes a handover module 1204 for sending and delaying sending of handover command. The processing system 1214 may also include an adjustment module 1206 for adjusting a handover holding time period and an absolute signal quality threshold. The modules 1202, 1204 and 1206 may be software modules running in the processor 1222, resident/stored in the computer-readable medium 1226, one or more hardware modules coupled to the processor 1222, or some combination thereof. The processing system 1214 may be a component of the UE 450 of FIG. 4 and may include the memory 482, and/or the controller/processor 480.

In one configuration, an apparatus, such as a base station 410, is configured for wireless communication including means for determining whether to delay sending a handover command to the UE. In one aspect, the determining means may be the antennas 434, the receive processor 438, the controller/processor 440, the memory 442, the handover management module 421, the determining module 1202, and/or the processing system 1214 configured to perform the functions recited by the determining means. In one configuration, the means and functions correspond to the aforementioned structures. In another aspect, the aforementioned means may be a module or any apparatus configured to perform the functions recited by the determining means.

The base station 410 is also configured to include means for delaying sending the handover command. In one aspect, the delaying means may include the antennas 434, the transmit processor 420, the controller/processor 440, the memory 442, the handover management module 421, the handover module 1204, and/or the processing system 1214 configured to perform the functions recited by the delaying means. In one configuration, the means and functions correspond to the aforementioned structures. In another aspect, the aforementioned means may be a module or any apparatus configured to perform the functions recited by the delaying means.

The base station 410 is also configured to include means for sending the handover command. In one aspect, the sending means may include the antennas 434, the transmit processor 420, the controller/processor 440, the memory 442, the handover management module 421, the handover module 1204, and/or the processing system 1214 configured to perform the functions recited by the delaying means. In one configuration, the means and functions correspond to the aforementioned structures. In another aspect, the aforementioned means may be a module or any apparatus configured to perform the functions recited by the sending means.

The base station 410 is also configured to include means for adjusting a handover holding time period and an absolute signal quality threshold. In one aspect, the adjusting means may include the antennas 434, the receive processor 438, the transmit processor 420, the controller/processor 440, the memory 442, the handover management reporting module 491, the handover module 1204, the adjustment module 1206 and/or the processing system 1214 configured to perform the functions recited by the switching means. In one configuration, the means and functions correspond to the aforementioned structures. In another aspect, the aforementioned means may be a module or any apparatus configured to perform the functions recited by the adjusting means.

Several aspects of a telecommunications system has been presented with reference to TD-SCDMA and LTE (in FDD, TDD, or both modes). As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other systems, such as or LTE-advanced (LTE-A), W-CDMA, high speed downlink packet access (HSDPA), high speed uplink packet access (HSUPA), high speed packet access plus (HSPA+) and TD-CDMA. Various aspects may also be extended to systems employing ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric, such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication at a user equipment (UE) during a call setup, comprising:
determining whether to delay sending an inter-RAT (radio access technology) measurement report or an intra-RAT measurement report based at least in part on a current status of the call setup and whether both the UE and a network support an inter-RAT handover while in the current status of the call setup, a network being a serving network or a target network;
delaying sending the intra-RAT measurement report for an intra-RAT measurement report holding time period and/or an inter-RAT measurement report for an inter-RAT measurement report holding time period based at least in part on the determination; and
sending the intra-RAT measurement report and/or the inter-RAT measurement report when the intra-RAT measurement report holding time period and/or the inter-RAT measurement report holding time period expire and/or the current status of the call setup changes to the new current status of the call setup in which both the UE and the network support the inter-RAT handover.

2. The method of claim 1, in which determining is further based on at least one of:
whether a signal quality of a current serving cell is above a first UE-defined absolute threshold and whether the signal quality of a neighbor cell is above a second UE-defined absolute threshold; and
whether the current serving cell of a first RAT or the neighbor cell of a second RAT provides a better QoS (quality of service) to an active service or application running at the UE.

3. The method of claim 2, further comprising:
adjusting the first UE-defined absolute threshold and/or the second UE-defined absolute threshold based at least in part on one of a UE speed, a UE receiver performance, a serving cell radio frequency (RF) variation trend, and application quality of service (QoS) specifications; and
adjusting the inter-RAT measurement report holding time period and/or the intra-RAT measurement report holding time period based at least in part on one of the UE speed, a current serving cell RF variation trend, a number of intra and/or inter-frequency neighbors, application QoS specifications and a percentage of call setup completion.

4. The method of claim 2, further comprising:
delaying sending the intra-RAT measurement report when the signal quality of the current serving cell is above the first UE-defined absolute threshold and an intra-RAT neighbor cell signal quality is below the second UE-defined absolute threshold.

5. The method of claim 2, further comprising:
sending the intra-RAT measurement report when the signal quality of the current serving cell becomes lower than the first UE-defined absolute threshold and the signal quality of an intra-RAT neighbor cell becomes higher than the second UE-defined absolute threshold.

6. The method of claim 2, further comprising:
sending the inter-RAT measurement report when both the UE and the network support the inter-RAT handover while in the current status of the call setup and the signal quality of each of the current serving cell and an intra-RAT neighbor cell become lower than the first UE-defined absolute threshold.

7. The method of claim 2, further comprising:
delaying sending the intra-RAT measurement report when a signal quality difference between the current serving cell and an intra-RAT neighbor cell is below a UE-defined relative threshold; and
sending the intra-RAT measurement report when the signal quality difference between the current serving cell and an intra-RAT neighbor cell is above a relative threshold.

8. The method of claim 1, further comprising:
delaying sending the inter-RAT measurement report when a current call is in the call setup or when at least one of the UE, the serving network or the target network do not support the inter-RAT handover during the call setup.

9. The method of claim 1, further comprising:
reducing a frequency of inter-RAT measurements when at least one of the UE, the serving network and the target network does not support the inter-RAT handover while in the current status of the call setup.

10. The method of claim 1, in which the current status of the call setup comprises one of: alerting, pre-alerting, before default bearer establishment for signaling, after default bearer establishment for signaling, before dedicated bearer establishment for traffic and after dedicated bearer establishment for traffic.

11. An apparatus for wireless communication, comprising:
a memory;
a transceiver configured to communicate with a network;
at least one processor coupled to the memory, the at least one processor being configured:
to determine whether to delay sending an inter-inter-radio access technology (RAT) measurement report or an intra-RAT measurement report based at least in part on a current status of a call setup and whether a UE and a network support an inter-RAT handover while in the current status of the call setup, a network being a serving network or a target network;
to delay sending the intra-RAT measurement report for an intra-RAT measurement report holding time period and/or the inter-RAT measurement report for an inter-RAT measurement report holding time period based at least in part on the determination; and
to send the intra-RAT measurement report and/or the inter-RAT measurement report when the intra-RAT measurement report holding time period and/or the inter-RAT measurement report holding time period expire and/or the current status of the call setup changes to the new current status of the call setup in which both the UE and the network support the inter-RAT handover.

12. The apparatus of claim 11, in which determining is further based on at least one of:
whether a signal quality of a current serving cell is above a first UE-defined absolute threshold and whether the signal quality of a neighbor cell is above a second UE-defined absolute threshold; and
whether the current serving cell of a first RAT or the neighbor cell of a second RAT provides a better QoS (quality of service) to an active service or application running at the UE.

13. The apparatus of claim 12, in which the at least one processor is further configured:
to adjust the first UE-defined absolute threshold and/or the second UE-defined absolute threshold based at least in part on one of a UE speed, a UE receiver performance, a serving cell radio frequency (RF) variation trend, and application quality of service (QoS) specifications; and
to adjust the inter-RAT measurement report holding time period and/or the intra-RAT measurement report holding time period based at least in part on one of the UE speed, a current serving cell RF variation trend, a number of intra and/or inter-frequency neighbors, application QoS specifications and a percentage of call setup completion.

14. The apparatus of claim 12, in which the at least one processor is further configured:
to delay sending the intra-RAT measurement report when the signal quality of the current serving cell is above the first UE-defined absolute threshold and the of an intra-RAT neighbor cell signal quality is below the second UE-defined absolute threshold.

15. The apparatus of claim 12, in which the at least one processor is further configured:
to send the intra-RAT measurement report when the signal quality of the current serving cell becomes lower than the first UE-defined absolute threshold and the signal quality of an intra-RAT neighbor cell becomes higher than the second UE-defined absolute threshold.

16. The apparatus of claim 12, in which the at least one processor is further configured:
to send the inter-RAT measurement report when both the UE and the network support the inter-RAT handover while in the current status of the call setup, and the signal quality of each of the current serving cell and an intra-RAT neighbor cell become lower than the first UE-defined absolute threshold.

17. The apparatus of claim 12, in which the at least one processor is further configured:
to delay sending the intra-RAT measurement report when a signal quality difference between the current serving cell and an intra-RAT neighbor cell is below a UE-defined relative threshold; and
to send the intra-RAT measurement report when the signal quality difference between the current serving cell and intra-RAT neighbor cell is above a relative threshold.

18. The apparatus of claim 11, in which the at least one processor is further configured:
to delay sending the inter-RAT measurement report when a current call is in the call setup or when at least one of the UE, the serving network or the target network do not support the inter-RAT handover during the call setup.

19. The apparatus of claim 11, in which the at least one processor is further configured:
to reduce a frequency of inter-RAT measurements when at least one of the UE, the serving network and the target network does not support the inter-RAT handover while in the current status of the call setup.

20. The apparatus of claim 11, in which the current status of the call setup comprises one of: alerting, pre-alerting, before default bearer establishment for signaling, after default bearer establishment for signaling, before dedicated bearer establishment for traffic, and after dedicated bearer establishment for traffic.

21. A method of wireless communication at a network, comprising:
determining whether to delay sending to a user equipment (UE) an inter-radio access technology (RAT) handover command or an intra-RAT handover command based at least in part on a current status of a call setup and whether the UE and a network support an inter-RAT handover while in the current status of the call setup, the network being a serving network or a target network;
delaying sending the intra-RAT handover command for an intra-RAT handover holding time period and/or the inter-RAT handover command for an inter-RAT handover holding time period based at least in part on the determination; and
sending the intra-RAT handover command and/or the inter-RAT handover command when the intra-RAT handover holding time period and/or the inter-RAT handover holding time period expire, and/or the call setup changes to the new current status in which both the UE and the network support the inter-RAT handover.

22. The method of claim 21, further comprising:
adjusting the inter-RAT handover holding time period and/or the intra-RAT handover holding time period based at least in part on one of a UE speed measured at the network, a current serving cell radio frequency variation trend reported by the UE, a number of intra and/or inter-frequency neighbors, application QoS specifications, a percentage of call setup completion, a signal quality of a serving cell and the signal quality of a target cell reported by the UE.

23. The method of claim 22, further comprising:
sending the intra-RAT handover command when the signal quality of the serving cell reported from the UE becomes lower than a first network-defined absolute threshold and the signal quality of an intra-RAT neighbor cell reported from the UE becomes higher than a second network-defined absolute threshold.

24. The method of claim 23, further comprising:
sending the inter-RAT handover command to the UE when both the UE and the network support the inter-RAT handover while in the current status of the call setup, and the signal quality of each of the current serving cell and the intra-RAT neighbor cell becomes lower than the first network-defined absolute threshold.

25. The method of claim 21, further comprising:
delaying sending the intra-RAT handover command when a signal quality difference between a signal quality of a serving cell and the signal quality of the intra-RAT neighbor cell is below a first network-defined relative threshold; and
sending the intra-RAT handover command when the signal quality difference is above a second network-defined relative threshold.

26. The method of claim 21, further comprising:
delaying sending the inter-RAT handover command when at least one of the UE, the serving network and the target network does not support the inter-RAT handover while in the current status of the call setup.

27. An apparatus for wireless communication, comprising:
a memory; and
at least one processor coupled to the memory, the at least one processor being configured:
to determine whether to delay sending to a user equipment (UE) an inter-radio access technology (RAT) handover command or an intra-RAT handover command based at least in part on a current status of a call setup and whether the UE and a network support an inter-RAT handover while in the current status of the call setup, a network being a serving network or a target network;
to delay sending the intra-RAT handover command for an intra-RAT handover holding time period and/or the inter-RAT handover command for an inter-RAT handover holding time period based at least in part on the determination; and
to send the intra-RAT handover command and/or the inter-RAT handover command when the intra-RAT handover holding time period and/or the inter-RAT handover holding time period expire, and/or the call setup changes to the new current status in which both the UE and the network support the inter-RAT handover.

28. The apparatus of claim 27, in which the at least one processor is further configured:
to adjust the inter-RAT handover holding time period and/or the intra-RAT handover holding time period based at least in part on one of a UE speed measured at the network, a current serving cell radio frequency variation trend reported by the UE, a number of intra and/or inter-frequency neighbors, application QoS specifications, a percentage of call setup completion, a signal quality of a serving cell and the signal quality of a target cell reported by the UE.

29. The apparatus of claim 28, in which the at least one processor is further configured:
to send the intra-RAT handover command when the signal quality of the serving cell reported from the UE becomes lower than a first network-defined absolute threshold and the signal quality of an intra-RAT neighbor cell reported from the UE becomes higher than a second network-defined absolute threshold.

30. The apparatus of claim 29, in which the at least one processor is further configured:
to send the inter-RAT handover command to the UE when both the UE and the network support the inter-RAT handover while in the current status of the call setup, and the signal quality of each of the current serving cell and the intra-RAT neighbor cell becomes lower than the first network-defined absolute threshold.
